(19) United States
(12) Patent Application Publication
(10) Pub. No.: US 2013/0226803 A1
(43) Pub. Date: Aug. 29, 2013

(54) METHOD AND SYSTEM FOR AUTHENTICATING AN ENTITY USING TRANSACTION PROCESSING

(71) Applicant: MasterCard International Incorporated, (US)

(72) Inventors: Anna HSU, Larchmont, NY (US); David GROSSMAN, Brooklyn, NY (US); Michael ZHAO, New York, NY (US); Justin X. HOWE, Oakdale, NY (US)

(73) Assignee: MasterCard International Incorporated, Purchase, NY (US)

(21) Appl. No.: 13/777,945

(22) Filed: Feb. 26, 2013

Related U.S. Application Data
(60) Provisional application No. 61/603,762, filed on Feb. 27, 2012.

(51) Int. Cl. G06Q 20/38

(52) U.S. Cl. CPC G06Q 20/382
USPC 705/44

(57) ABSTRACT

A system for authenticating an entity includes a database configured to store a profile associated with an entity, the profile including at least an authentication status; a supplying device configured to supply transaction details including a unique virtual payment number (VPN) to a third party entity to be authenticated; a receiving means for receiving an authorization request that includes transaction details that include a VPN; and a processor configured to capture, from the authorization request, transaction details for a payment card transaction wherein the transaction details includes at least a payment card number, authenticate the entity requesting a transaction by comparing the captured transaction details including a payment card number to the supplied unique VPN, and update, in the database, the authentication status in the profile associated with the entity based on the authenticating of the entity based on said authentication.

### RELATED APPLICATION

This application claims the priority benefit of commonly assigned U.S. Provisional Application No. 61/603,762, filed Feb. 27, 2012, for “Method and System for Authenticating an Entity Using Transaction Processing,” by Anna Hsu et al., which is herein incorporated by reference in its entirety.

### FIELD

The present disclosure relates to authenticating an entity using payment card transaction processing, specifically authenticating an entity by a payment number associated with the entity by processing a financial transaction without requiring the transfer of funds.

### BACKGROUND

In the growing age of cloud computing and acceptance of transacting confidential communications over relatively open networks such as the Internet, the need for verifying the identity of an entity has become increasingly important. In particular, phishing attacks are common and can create valid concern about who one is communicating with. To address this concern when accessing banking accounts over the Internet, a special cookie is placed on a computer known to be associated with an account holder, typically after a challenge protocol that requires the user to input a password and/or answer questions. Alternatively, a code is set to the account holder via e-mail or text message using an addressor's mobile number associated with the user. These techniques, however, do not assure the account holder as to the authenticity of the on-line bank. It also requires that the password, e-mail questions, etc., be prearranged, which can be stolen or accessed in a way as to potentially compromise the account.

Authentication is of particular concern when an entity is requesting confidential information, such as analytical reports about itself, account information, or other types of information concerning itself, from a custodian of such confidential information. It can be important for the custodian delivering the information to authenticate that the entity requesting the information is the party entitled to the information.

Further, in an e-commerce environment, more and more financial transactions, like consumer purchases of goods and services or fund transfers, are performed on the Internet. When engaging in a financial transaction through the Internet, customers often assume a level of risk, real or imagined, when dealing with relatively unknown entities. Customers may be wary of providing personal information, account information, or transferring money to entities without assurances that the entity is who they claim to be. As a result, online retailers and services have taken steps to try and reduce risk and alleviate customer security and privacy concerns such as displaying certificates from third parties. But there is an awareness that these too may not be authentic, and may not be a proper indicator of the authenticity of the entity.

Existing processes for authenticating entities include transferring a small amount of funds to a financial account of the entity and requiring the entity to prove the receipt of the funds, such as by confirming the transferred amount or amounts. However, this only shows that the entity is at least a representative of the account holder, and not that the entity has actual access to the financial account. Furthermore, this can become costly for the authentication processor, which might conduct a large number of fund transfers or incurring transaction or interchange fees as well. Further, there may be security risks involved with using the actual financial account of the entity, especially if it is determined that the entity ends up not being who they presented themselves as being. There is a perceived opportunity to improve the authentication of merchants and entities in e-commerce as to reduce risk and increase security for customers engaging in financial transactions. This is particularly so in light of the technical problems and inadequacies of earlier attempts at providing authentication.

### SUMMARY

The present disclosure provides a description of a system and method for authenticating an entity using transaction processing. There are two basic approaches described herein. One involves a custodian of a confidential or private information and/or funds (such as a payment network, payment card issuing bank, transaction acquirer bank, etc., referred to here as a “processor”) authenticating an entity capable of running a transaction through a payment network (such as a merchant, vendor or the like, referred to here as a “merchant” or “entity”) prior to releasing information and/or funds to the entity. For example, a merchant may want to receive a report about itself from a business analytics company, which could be a separate entity or part of a payment card network, for example. The processor, e.g., as or at the request of the analytics company, would send the merchant (or to the party requesting the entity be authenticated, which would then send it to the merchant) a payment number (PN and optionally other transaction details, such as a specific transaction amount, a specified personal identification number (PIN) (e.g., an invalid pin to serve as a marker), or other details suitable for merchant authentication. A specific transaction amount may be chosen such that a consumer would not be able to initiate a transaction for that amount in order to imitate the entity. The merchant could initiate a transaction (e.g., a conventional request for authorization for a payment card transaction) using transaction details including at least the PN. The payment network could then receive the transaction details and information about the entity (e.g., its location), and compare at least the PN to what it expected to receive as an indication of the authenticity of the entity. The location, for instance, would then be recorded or compare to the expected location. A transaction could then be carried out with the party authenticated as a representative of this merchant location. If the PN provided is a unique virtual payment number (VPN), then the transaction would not need to be completed (e.g., an issuing bank would not have to be contacted with an authorization request), because the unique VPN was issued by the processor, identified and processed, not as a normal payment card transaction, but as a request for authentication. Hence, no funds would have to be transferred.

For instance, a merchant requesting access to its transaction records at a payment network could be sent a one-time use VPN and a specified amount (e.g., 13 cents). The merchant would then process a transaction with this VPN for this amount from the location for which it wishes to access its records. The payment processor, upon receipt of the transaction details would route the transactions, via the VPN routing number, to a database server that would then check the transaction details, and decline the transaction. The financial account may be maintained as having a $0 balance, such that all authorization requests will be denied. If the transaction details are as expected, then the location of the transaction is recorded, and a communication (e-mail, network message in the decline, SMS message, voice message) is sent to the merchant saying its location has been verified. The merchant can then access the report for that location.

The other approach disclosed herein facilitates authentication of an entity, such as a merchant, for a third party, such as a customer, by a processor prior to the customer transacting business, such as supplying confidential or private information or funds, to the entity by the third party or visa versa. In this approach, the processor would supply the customer with at least a PN, which may be unique (such as a one time use VPN) or, if not, at least one additional unique transaction detail, such as a one time use PIN. Other transaction details, such as a specific transaction amount, could optionally be supplied by the customer or the processor. The customer then would give at least the PN and any additional transaction details required for uniqueness, and other supplied transaction details to the entity, which would then initiate an authorization request using at least the PN and any additional transaction details required for uniqueness, and other supplied transaction details, and the processor would route the PN and any additional transaction details required for uniqueness to a server to compare the received transaction details to those it expected to receive. The location of the entity can then be identified or confirmed, for instance. In this way, for instance, a processor can authenticate an on-line merchant by its location (either a point of sale (POS) (virtual or physical) or web address, as examples). The processor can then provide this authentication to the customer, perhaps with an indication of the score of the merchant's reputation, or other information that may serve to assist the customer in deciding whether to conduct business with this merchant.

As can be seen, both approaches involve initiating a payment card account transaction using at least a PN to the entity by or at the request of a party requesting authentication of the entity. The entity receiving the PN then initiates a transaction through the payment network. The transaction details forwarded to the payment network include at least the PN and information regarding the identity of the entity as is conventional, such as its location (geographic location and/or location on a network by address), and any additional transaction details required for uniqueness. For instance, a specified transaction amount that is unfeasible for a customer to produce to imitate the entity, or unique VPN, unique PIN or some unique combination of traditional transaction details (e.g., PN, date, time, amount, merchant name, and location) that may be unique to the original authentication request. If the transaction details match what is expected, then the entity can be authenticated, optionally with an indication of a degree of certainty, to the party requesting authentication. The transaction may be handled in a way that does not require any exchange of funds.

In this way, a technical solution is provided for a long-standing technical problem of verifying an entity, and can be particularly advantageous because it uses components of a legacy system (e.g., InControl VPNs from MasterCard).

### BRIEF DESCRIPTION OF THE DRAWING FIGURES

Exemplary embodiments are best understood from the following detailed description when read in conjunction with the accompanying drawings. Included in the drawings are the following figures:

FIGS. 1A and 1B are block diagrams illustrating a first and second system for authenticating an entity in accordance with exemplary embodiments.

FIG. 2 is a block diagram illustrating a processing server in accordance with exemplary embodiments

FIGS. 3A and 3B are a flow diagram illustrating a first exemplary method for authenticating an entity in accordance with exemplary embodiments.

FIG. 4 is a flow chart illustrating a first exemplary method of authenticating an entity in accordance with exemplary embodiments.

FIGS. 5A and 5B are a flow diagram illustrating a second exemplary method for authenticating an entity in accordance with exemplary embodiments.

FIG. 6 is a flow chart illustrating a second exemplary method of authenticating an entity in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### System for Authentication Overview

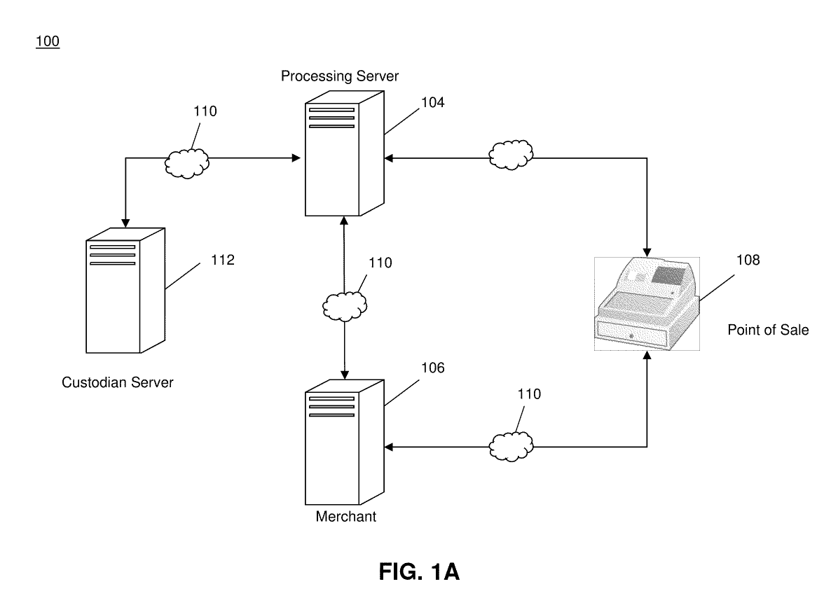

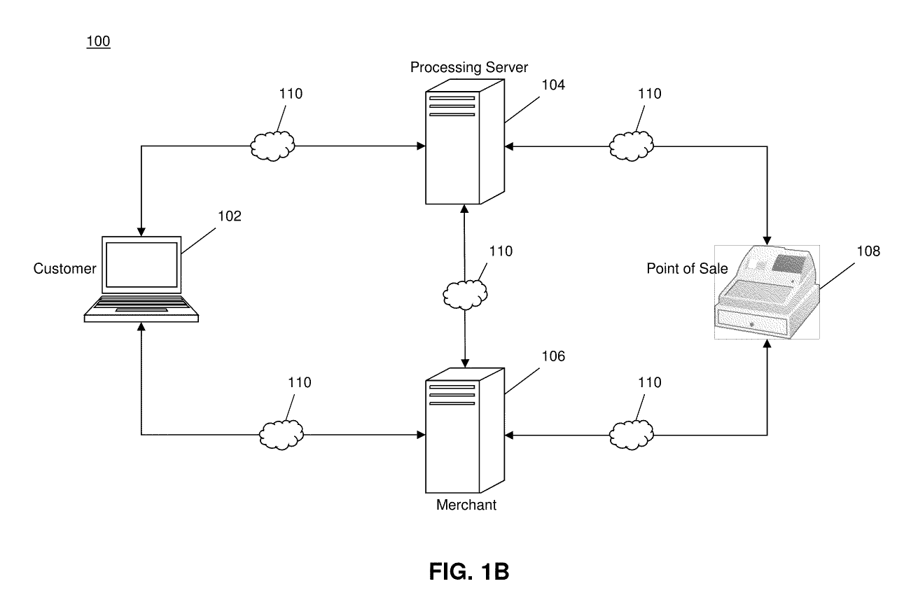

FIG. 1A illustrates a system 100 for authenticating an entity. The system 100 may include a processing server 104, a merchant 106 and a point-of-sale (POS) 108 controlled by the merchant, though the POS 108 and the merchant 106 should be co-located geographically or on a network (e.g., same domain). Each of the components may be connected to a network 110. The network 110 may be any type of wired or wireless network suitable for performing the function as disclosed herein as will be apparent to persons having skill in the relevant art. These include local area networks (LANs), wireless area networks, the internet, Wi-Fi, fiber optic, coaxial cable, infrared, radio frequency, etc., in combinations thereof. For example, the network 110 may be part of a payment card processing network such as MasterCard's BankNet. The merchant 106 may wish to receive information from a custodian 112 of confidential, private, or sensitive information. The custodian 112 may or may not be part of a processing server 104. The processing server 104 can serve to authenticate the merchant 106 prior to the release of such information from the custodian 112, for instance. It should be noted that the custodian 112, processing server 104, POS 108 and merchant 106 are computers or computer systems, but in certain limited instances the custodian 112 and the merchant can be natural persons in communication through a network.

The processing server 104 may be configured to transmit an authentication request to the merchant 106 (e.g., a merchant acceptance location), as discussed in more detail below. More specifically, the merchant 106 may request access to the information held by the custodian 112. The processing server 104 may be any type of server suitable for performing the functions described herein, such as a general purpose computer, configured as disclosed herein to become a specific purpose computer, or cloud computing or any other form of computer capable of carrying out the functions described herein. The processing server 104 may be a single system, e.g., a single specific purpose computer, or may be comprised of several interconnected computers via for instance a network 110, or servers as in a server form. The processing server 104 may be configured to supply a payment number (PN) and additional transaction details that may be required to uniquely authenticate the merchant 106, as discussed in more detail below. The merchant 106 can be configured to receive the PN and, for instance, an optional authentication charge amount, and to initiate a transaction via a point of sale 108. The point of sale 108 would be at the same location, either physical or virtual, as the merchant. That is, the merchant 106 and the point of sale 108 can be in the same store and the communication protocol for the transaction would identify the merchant location via the network 110 to the processing server 104. Alternatively, if the merchant 106 is an on-line merchant, the point of sale 108 would be the transaction server and the location would be a network address, for instance, such as a domain. The point of sale 108 can be a general purpose point of sale system, requiring no alternative configuration than used for normal payment number processing. The point of sale 108 may process the transaction by transmitting transaction details of the processing server 104. The processing server 104 may then authenticate the merchant 106 based on the transaction details, as discussed in more detail below. In an exemplary embodiment, the processing server may not process the transaction such that no transfer of funds will occur. Rather, the processing server 104 would decline a transaction based on the unique VPN, but would route the VPN to a database to compare and verify the transaction details as part of the authentication process. Upon authenticating the merchant 106, the processing server 104 may notify the merchant 106 of the authentication, which may then engage in accessing the information held by the custodian 112, for instance.

FIG. 1B illustrates a system 100 for authenticating an entity similar to that shown in FIG. 1A but additionally including a third party requesting that an entity be authenticated, called a “customer” and understood to be any entity (person or business for example) that wishes to authenticate an entity 106. The system 100 may include a customer 102, a processing server 104, a merchant 106, and a point of sale 108. The customer 102 is in the form of a computer capable of communication owned or controlled by a person who is interested in authenticating an entity (and does not have to be a prospective customer). In some instances, communications can occur with a natural person. Each of the components may be connected to a network 110. The network 110 may be any type of wired or wireless network suitable for performing the functions disclosed herein as will be apparent to persons having skill in the relevant art, such as local area networks (LANs), wireless area networks (WANs), the Internet, Wi-Fi, fiber optic, coaxial cable, infrared, radio frequency (RF), etc., and combinations thereof, such as in a payment processing network.

The customer 102 may have a desire to engage in a financial transaction with an entity. The entity may be any entity that is capable of engaging in a financial transaction, such as the merchant 106, a person, a business, etc. The financial transaction may be any transaction between two parties (e.g., between the customer 102 and the merchant 106) that includes the transfer of funds from one party (e.g., the customer 102) to the other party (e.g., the merchant 106), such as the purchase of goods or services, the giving or repayment of a loan, a refund, etc. The customer 102 may have a desire to authenticate the identity of the merchant 102 prior to engaging in the financial transaction.

The processing server 104 may be configured to receive an authentication request from the customer 102 and to authenticate the merchant 106, as discussed in more detail below. The processing server 104 may be any type of server suitable for performing the functions as disclosed herein, such as a general purpose computer configured as disclosed herein to become a specific purpose computer, etc. The processing server 104 may be a single system (e.g., a single specific purpose computer) or may be comprised of several interconnected (e.g., physically or through a network, such as the network 110) systems or servers (e.g., a server farm). The processing server 104 may be configured to supply a payment number (PN), and any additional transaction details required for uniqueness, such as a one time use VPN, a one time use PIN, or any combination of traditional transaction details that, in combination, may result in a unique authorization request (e.g., such as a unique authorization code, PN, date, and/or transaction amount), which may be transmitted to the merchant 106.

The merchant 106 may be configured to receive the PN and any additional transaction details, and to initiate a transaction on the point of sale 108. Point of sale systems and devices suitable for performing the functions as disclosed herein will be apparent to persons having skill in the relevant art. In an exemplary embodiment, the point of sale 108 is a general purpose point of sale system. The point of sale 108 may process the transaction by transmitting transaction details to the processing server 104. The processing server 104 may then authenticate the merchant 106 based on the transaction details, as discussed in more detail below. In an exemplary embodiment, the processing server 104 may not process the transaction, such that no transfer of funds will occur. In an alternative embodiment, the authorization request may be such that the transaction will be denied (e.g., a PN tied to an account with a zero balance, a zero transaction amount, a denied PIN, etc.) Upon authenticating the merchant 106, the processing server 104 may notify the customer 102 of the authentication, who may then engage in a financial transaction with the merchant 106.

### Exemplary Processing Server

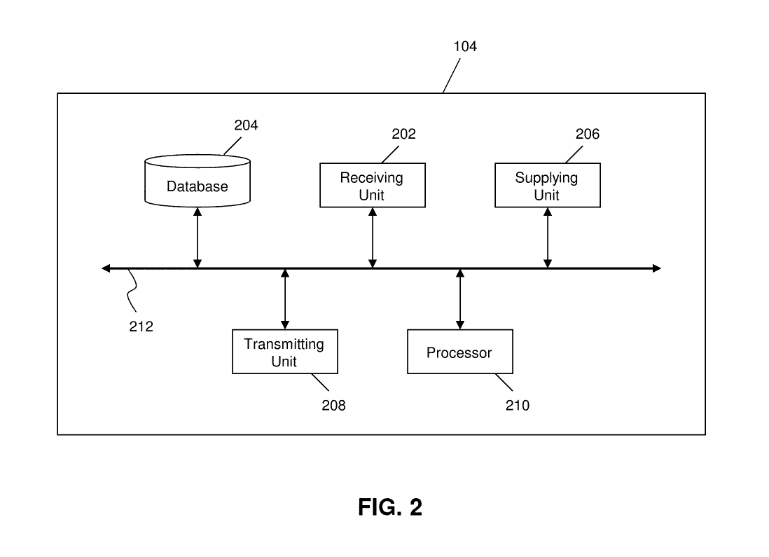

FIG. 2 is a block diagram of the processing server 104. The processing server 104 may include a receiving unit 202, a database 204, a supplying unit 206, a transmitting unit 208, and a processor 210. Each of the components may be connected via a bus 212. Suitable types and configurations of the bus 212 will be apparent to persons having skill in the relevant art.

The receiving unit 202 may be configured to receive (e.g., via the network 110) an authentication request (e.g., from the customer 102). It may be in the form of a network gateway, or other equipment capable of receiving and processing communications over a network. In addition to the PN, the authentication request may include at least an entity name, such as the name of a merchant (e.g., the merchant 104) with which the requester desires to transact with, as well as any additional transaction details that may be required for uniqueness.

The database 204 may be configured to store a profile associated with the merchant 104. The profile may include at least an authentication status for the merchant 104, generally but not limited to the geological or virtual (e.g., network domain) location of the merchant or the part of the merchant that a future communication or transaction is to occur. The authentication status may be an indication of if the merchant 104 has been successfully authenticated. In some embodiments, the profile may also include account information for a financial account associated with the merchant 104, to or from which the merchant 104 wishes to transact. In a further embodiment, multiple financial accounts may be associated with the merchant 104, or the merchant 104 may be associated with multiple profiles each including a unique financial account.

The database 204 may be configured in any type of suitable database configuration, such as a relational database, a structured query language (SQL) database, a distributed database, an object database, etc. The data in the database 204 may be stored on any type of suitable computer readable media, such as optical storage (e.g., a compact disc, digital versatile disc, blu-ray disc, etc.) or magnetic tape storage (e.g., a hard disk drive). Suitable database configurations and data storage types will be apparent to persons having skill in the relevant art.

The supplying unit 206 may be configured to supply a payment number (PN), such as a one time VPN, and optionally an authentication charge amount or any other additional details required for uniqueness. The PN may be a randomly assigned, randomly chosen, and/or randomly generated unique virtual payment card number that might normally be mapped to a financial account but as used herein is used to capture identifying information from the merchant (e.g., merchant location and/or other data such as unique address of a computer, etc.). The unique VPN may provide the user with additional security and privacy. In one embodiment, the unique VPN may prevent the transfer of funds during the authentication of the entity and in fact, though processed using the payment network, is not used in a financial transaction. Methods for creating, selecting, and processing unique VPNs will be apparent to persons having skill in the relevant art, but can also be found in U.S. Pat. Nos. 7,567,934; 7,571,142; and 5,593,896, for instance. In some embodiments, a traditional PN may be used, along with other additional transaction details that may result in an authorization request being unique such that it can authenticate the entity.

The transmitting unit 208 may be configured to transmit the supplied PN and additional transaction details to a third party (e.g., such as the merchant 106, an acceptance location of the merchant 106, a merchant representative 114, etc.) via the network 110. The merchant 106 may then initiate a payment card transaction (e.g., using the point of sale 108) using the supplied PN and other additional transaction details (e.g., such as a specified transaction amount and/or unique PIN). The transaction request may be received by the receiving unit 202. The transaction request may be in a standardized format, such as the ISO 8583 standard defined by the International Organization for Standardization (IOS).

The processor 210 may be configured to capture transaction details from the received transaction request. The transaction details may include at least a payment card number. In one embodiment, the transaction details may also include a transaction amount, a merchant name, merchant identifier (e.g., a unique identification number associated with the merchant 106), a location identifier (e.g., a unique identification number associated with the point of sale 108), a date, and/or a PIN.

The processor 210 may be further configured to authenticate the merchant 106 based on the captured transaction details. Authentication may include comparing the captured payment card number to the supplied PN and optionally the captured transaction amount to the authentication charge amount. If the captured number and amount for the processed transaction match the supplied PN and authentication amount transmitted to the merchant, then the merchant 106 may be authenticated. In one embodiment, authenticating may also include comparing a received merchant name with the merchant 106 or a received merchant and/or location identifier with merchant and/or location identification numbers associated with the merchant 106 (e.g., and stored in the profile associated with the merchant 106 in the database 204). In an exemplary embodiment, the processor 210 may be configured to capture transaction details and authenticate the merchant 106 without processing the payment card transaction or otherwise initiating any transfer of funds. In instances where the authentication request may contain additional transaction details required for uniqueness (e.g., traditional transaction details in a unique combination), authentication of the entity may require the captured transaction details to match the transaction details supplied in the authorization request.

The processor 210 may be further configured to update the authentication status including in the profile associated with the merchant 106 in the database 204. The authentication status may be updated to reflect the success or failure to authenticate the merchant 106 and to record (or update) the location of the merchant 106. The transmitting unit 208 may be configured to notify the customer 102 of the updated authentication status of the merchant 106. The customer 102, the custodian 112 and/or the processor 104 may then feel confident in the authenticity of the merchant 106 and engage in a financial transaction with the merchant 106 from the same location.

### Process Flow of a Method for Authenticating an Entity

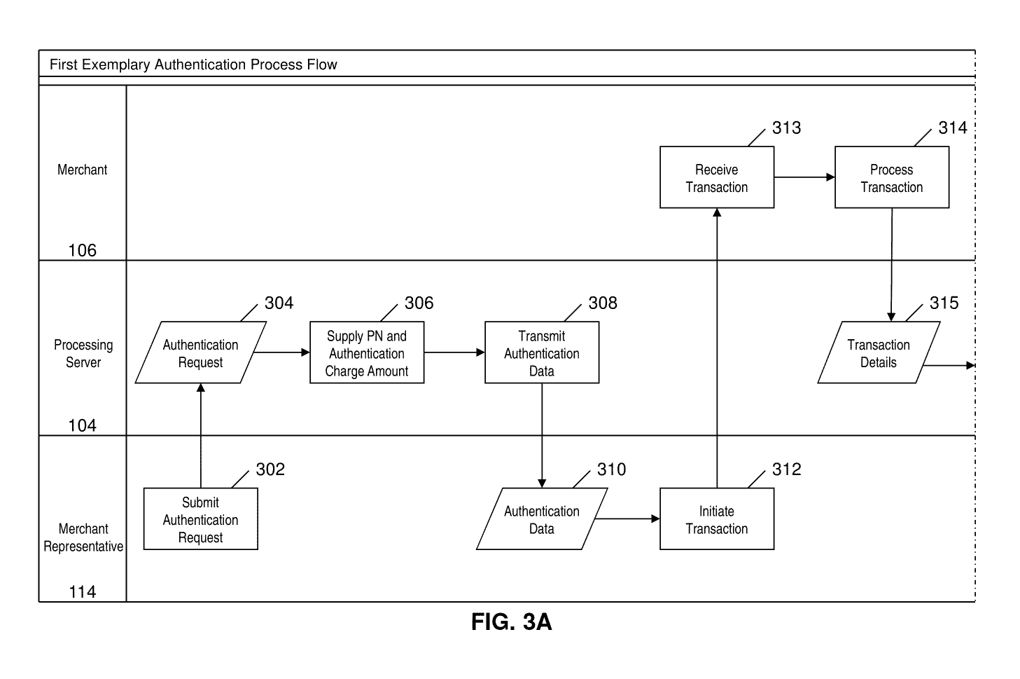

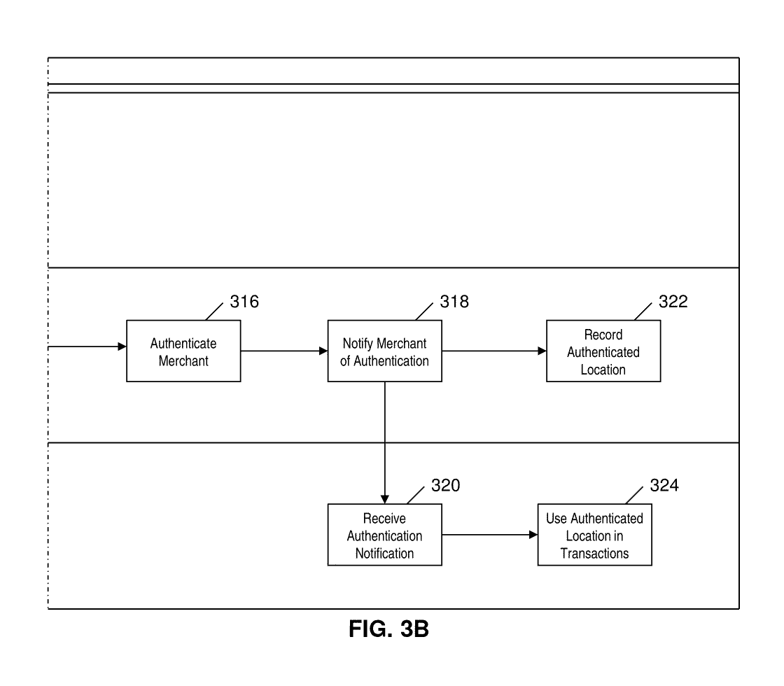

FIG. 3A is a flow diagram illustrating a first method for authenticating an entity upon the request of the same of the entity, the card processor, or a third party on behalf of the entity (e.g., such as the merchant representative 114 on behalf of the merchant 106). In step 302, the merchant representative may initiate an authorization request. The processing server 104 can receive the authentication request in step 304. The processing server 104 then can supply the PN an optionally an authentication charge amount (e.g., or any other additional transaction details required for uniqueness) for step 306. These transaction details are then transmitted as authentication data in step 308 to the merchant representative 114. The merchant 114 receives the authentication data 310 and initiates a standard transaction using the PN and any additional transaction details in step 312. The initiated transaction may be received by the merchant 106 (e.g., at a merchant acceptance location) in step 313 and processed (e.g., by the point of sale 108) in step 314. The transaction details are received at the processing server 104 in step 315. The merchant 106 is then authenticated in step 316. By authenticated, it is noted that the authentication can be a determination that the merchant is not the intended merchant. The PN transaction is actually declined in exemplary embodiments so as to avoid the processing fees and charging the PN with an amount. In step 318, the merchant representative 114 is notified of the authentication and in step 322, the processing server 104 records the authenticated location to be used in future transactions when as shown in step 324. Each transaction alleged to come from the merchant that originates without location can then be relied upon as the merchant's authenticated location. This can facilitate communication with the custodian of confidential, private or sensitive information 112, noting that this information can include financial transactions as well. The merchant representative 114 receives an authentication notification as well in step 320.

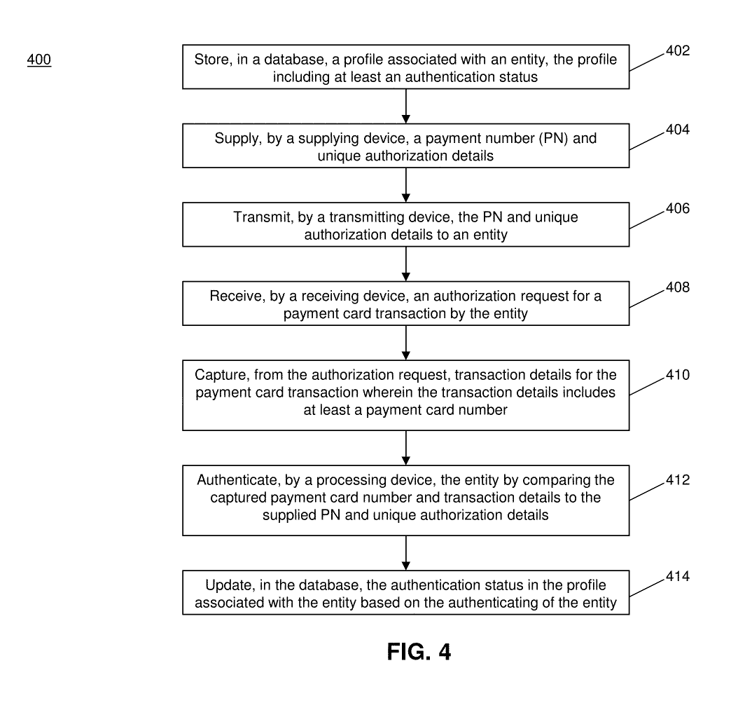

An exemplary merchant authentication process 400 is shown in FIG. 4. In FIG. 4, step 102 stores, in the database, a profile associated with an entity, the profile including at least an authentication status and a location. In step 404, a payment number (PN) and unique authorization details (as discussed above) are supplied, by virtue of the supplying unit. In one embodiment, the unique authorization details may include at least one of: (1) a unique transaction amount; (2) a unique personal identification number; and (3) a unique combination of traditional transaction details. In step 406, the supplied PN and unique authorization are transmitted, by a transmitting device, to the merchant 106. In step 408, an authorization request is received in the receiving device of the card processor 104 for a payment card transaction by the merchant 106. From the authorization request, transaction details are captured for the payment card transaction wherein the transaction details includes at least a payment card number, as shown in step 410. If the transaction details include the supplied PN, instead of conducting a payment card transaction, the supplied PN is used to authenticate, by a processing device, the entity by comparing the captured payment card number, in this instance the supplied PN, and the transaction details to the supplied PN and the unique authorization details. If they match, or are as expected, as shown in step 412, the merchant is authenticated with respect to the location information provided in the transaction. Thereafter, the database 204 is updated to show the authentication status in the profile based on the authentication step of the entity. The profile would also include such information as the merchant name, the merchant ID, and of course location.

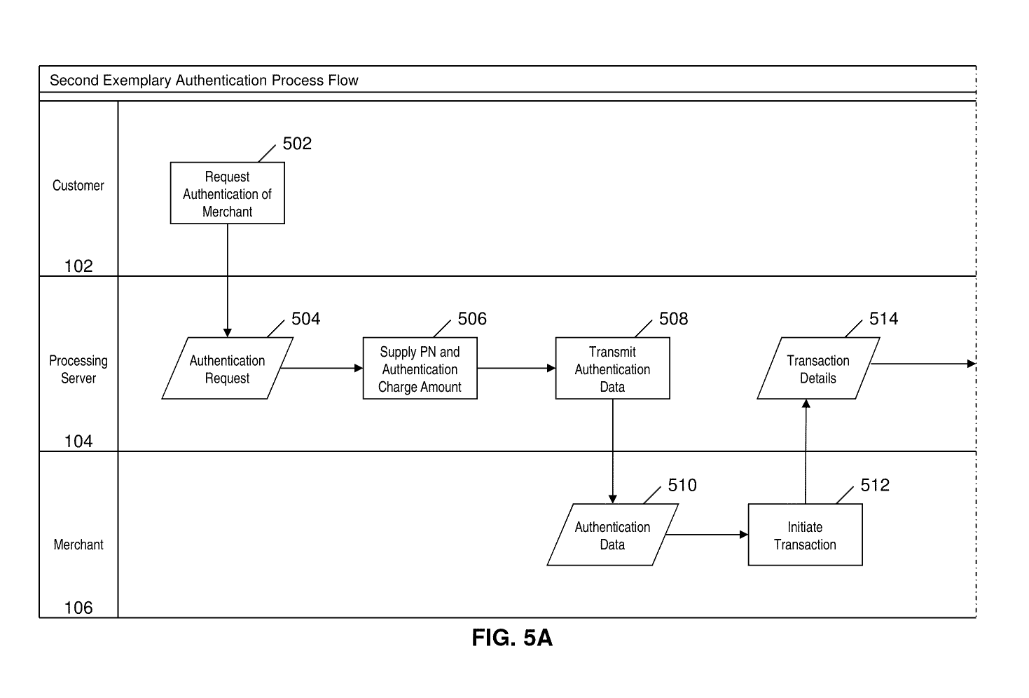

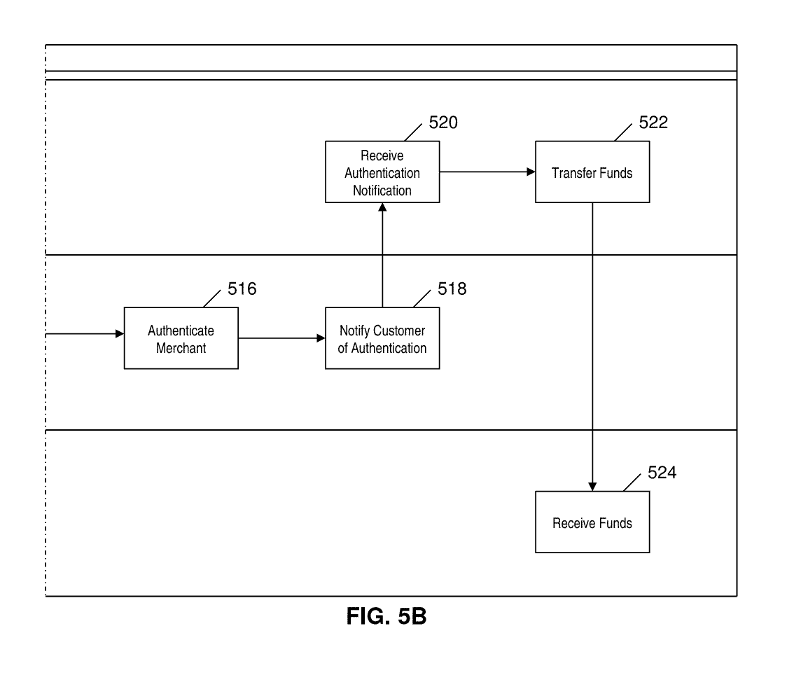

FIG. 5 is a flow diagram illustrating a second method for authentication of an entity upon the request of a customer.

In step 502, a customer (e.g., the customer 102) may request authentication of a merchant (e.g., the merchant 106). In an exemplary embodiment, the authentication request may include at least the name of the merchant 106 and the PN and merchant identification number associated with the merchant 106, a location identification number (e.g., associated with the point of sale 108 or a physical location of the merchant 106). In a further embodiment, the authentication request may further include a merchant identification number associated with the merchant 106, or a financial account associated with the merchant 106. The customer 102 may transmit (e.g., via the network 110) the authentication request to a processing server (e.g., the processing server 104). The authorization request can be conventional in nature. In one embodiment, the customer 102 may transmit the authentication request via a webpage by or on behalf of the processing server 104.

In step 504, the processing server 104 may receive the authentication request and upon identifying the PN, decline the transaction by sending a message to the merchant and initiating an authorization process. The processing server 104 may identify a profile (e.g., stored in the database 204) associated with PN and/or the merchant 106 based on the authentication request. If no profile is identified, the processing server 104 may create a profile for the merchant 106. Then, in step 506, the processing server 104 may have supplied the payment number (PN) and unique authorization details that may result in the authorization request being unique to the merchant 106 or specific transaction (e.g., an authentication charge amount, a personal identification number, or unique combination of traditional transaction details). In one embodiment, the processing server 104 may store the supplied PN and unique authorization details (e.g., the authentication charge amount) (e.g., in the database 204). In a further embodiment, the PN and authentication charge amount may be stored in the profile associated with the merchant 106.

In step 508, the processing server 104 may transmit (e.g., by the transmitting unit 208) authentication data to the merchant 106. The authentication data may include at least the unique PN and optionally the authentication charge amount. In one embodiment, the authentication data may further include a location identification number (e.g., corresponding to the point of sale 108) or other unique authorization details. In step 510, the merchant 106 may receive the authentication data. Using the authentication data, the merchant 106 may, in step 512, initiate a payment card transaction (e.g., using the point of sale 108). The payment card transaction may be initiated on a legacy point of sale system or device without the need for any specialized software or hardware.

In step 514, the processing server 104 may receive (e.g., by the receiving unit 202) transaction details for the initiated payment card transaction. In an exemplary embodiment, the transaction details may include at least a payment card number (e.g., normally used as the funding source for the payment card transaction) and the transaction amount. In a further embodiment, the transaction details may also include a merchant name, a merchant identifier and/or a location identifier.

In step 516, the processing server 104 may authenticate the merchant 106. The processing server 104 may authenticate the merchant 106 by comparing at least the payment card number and transaction amount with the supplied PN and optionally authentication charge amount. In one embodiment, the authentication may also include comparing received merchant name, merchant identifier, and/or location identifier with the name of the merchant 106, a stored merchant identification number, and/or a stored location identification number, respectively. In an exemplary embodiment, the processing server 104 may update the authentication status in the profile associated with the merchant 106 in the database 204 based on the results of the authentication. If positive, the merchant location is stored or updated. In another exemplary embodiment, the payment card transaction is not processed by the processing server 104, such that no transfer of funds occurs.

In step 518, the processing server 104 may notify (e.g., by the transmitting unit 208) the customer 102 of the success or failure of the authentication of the merchant 106. In one embodiment, the notification method may be included in the authorization request. Exemplary methods of notification may include electronic mail, a text message (e.g., a short message service message), notification via a webpage portal, or any other suitable method of notification as will be apparent to persons having skill in the relevant art. In step 520, the customer 102 may receive the notification (e.g., by viewing the email, logging in to the website where the authentication request was submitted, etc.). If the customer 102 is satisfied with the results, then the customer 102 may, in step 522, transfer funds to the merchant 106, who may receive the funds in step 524.

### Exemplary Method for Authenticating an Entity

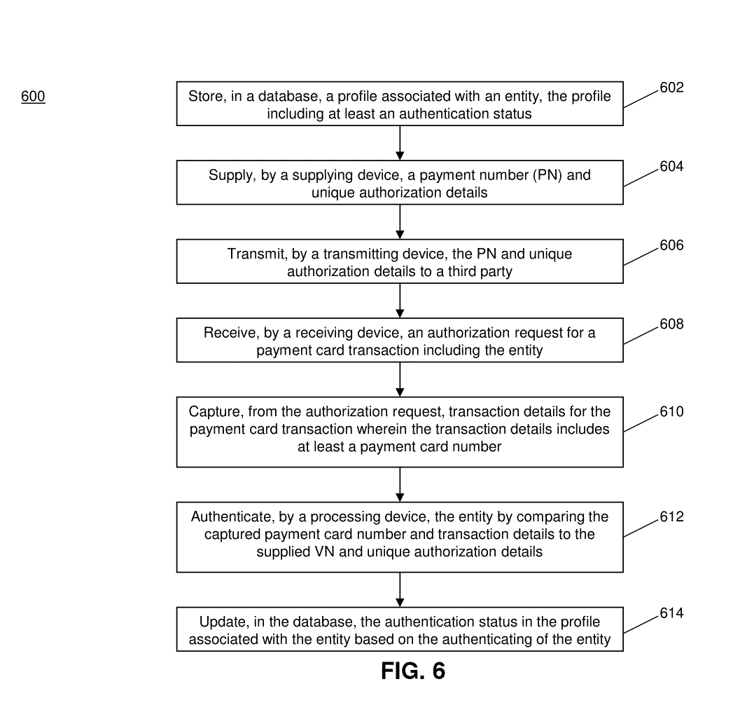

FIG. 6 illustrates an exemplary method 600 for authenticating an entity.

In step 602, a profile associated with an entity (e.g., the merchant 106) may be stored in a database (e.g., the database 204), the profile including at least an authentication status. In one embodiment, the profile may also include a name of the entity, an entity identification number, and/or a point of sale identification number. In a further embodiment, the profile may include a financial account associated with the entity.

In step 604, a payment number (PN) and unique authorization details may be supplied by a supplying device (e.g., the supplying unit 206). In one embodiment, the PN may be mapped to the financial account associated with the entity. In an exemplary embodiment, the supplied PN and unique authorization details may be stored in the profile associated with the entity. In some embodiments, the PN and unique authorization details may be randomly selected and/or randomly generated for security purposes. In one embodiment, the unique authorization details may include any details which result in the authorization request being unique such that the entity can be authenticated based on the authorization request. In an exemplary embodiment, the unique authorization details may include at least one of: (1) a unique transaction amount; (2) a unique personal identification number; and (3) a unique combination of traditional transaction details, such as PN, PIN, transaction amount, date, merchant name, location, or authorization code. In step 606, the PN and unique authorization details may be transmitted, by a transmitting device (e.g., the transmitting unit 208) to a third party. In an exemplary embodiment, the third party may be the entity. In an alternative embodiment, the third party may be acting on behalf of the entity (e.g., the merchant representative 114).

In step 608, an authorization request for a payment card transaction including the entity may be received by a receiving device (e.g., the receiving unit 202). In one embodiment the authorization request may be in a standardized format. In a further embodiment, the authorization request may be pursuant to the ISO 8583 standard defined by the International Organization for Standardization (IOS). In step 610, transaction details for the payment card transaction may be captured from the authorization request, the transaction details including at least a payment card number. In one embodiment, the transaction details may further include the transaction amount, an entity name, entity identifier, and/or point of sale identifier.

In step 612, a processing device (e.g., the processor 210) may authenticate the entity by comparing the captured payment card number and transaction details to the supplied PN and unique authorization details. In one embodiment, the authenticating step may also include comparing the captured entity name, entity identifier, and/or point of sale identifier to the respective name of the entity, entity identification number, and/or point of sale identification number stored in the profile associated with the entity. In step 614, the authentication status in the profile associated with the entity may be updated based on the authenticating of the entity. In an exemplary embodiment, the processing device may not process the payment card transaction, such that no transfer of funds occurs.

The method 600 may be useful in authenticating an entity, such as on behalf of a consumer (e.g., the consumer 102) for providing security and confidence when engaging in a financial transaction online. The authentication being performed by a payment card processor using a PN may further enable the authentication to be performed without the actual transfer of any funds, which may lower the expense of performing authentication over traditional systems. It should be understood that the possible applications for authenticating an entity by the systems and methods disclosed herein may exceed performing authentication for the purposes of providing added security for financial transactions in e-commerce.

For example, a payment card processor (e.g., MasterCard®) acting as the processing server 104 may be in a unique position to possess, beneficial market information. For instance, by processing a vast number of financial transactions, a payment card processor may be able to collect useful data on specific industries, markets, trends, consumers, geographic locations, etc. This type of information may be made available only to entities that can authenticate themselves as being a particular entity, of a particular industry, or in a particular location.

By way of example, a merchant (e.g., the merchant 106) at a specific geographic location (e.g., a specified postal code) may desire market reports on the status of the market in their specific geographic location. A payment card processor (e.g., the processing server 104) may compile market reports based on financial transactions processed in the area of the merchant based on location information captured from authorization requests (e.g., from identified data elements in an authorization request pursuant to ISO 8583). The payment card processor may request the merchant to authenticate themselves as being a merchant operating in the specific geographic location. The payment card processor may use authentication methods disclosed herein (e.g., the methods 400 and 600) and authenticate the merchant's location by capturing location identifier information in the authorization request (e.g., such as by specifying a particular point of sale terminal for the initiating of the financial transaction or based on a data element in the authorization request containing location information). Upon authenticating that the merchant is indeed in the specific geographic location, the payment card processor can feel confident in the distribution of the market report.

In some instances, a customer may benefit from authentication of an entity prior to engaging in a business contract or before providing or procuring services from the entity. For example, a customer (e.g., the customer 102) may be looking for a contractor for a project where the contractor may be exposed to sensitive information, and may have been referred to a specific merchant (e.g., the merchant 106) with a reputation for honesty and confidentiality. The customer may wish to contact the merchant 106 and have the merchant 106 authenticate their identity prior to discussing any details to receive an estimate, out of caution that an unreliable third party may be posing as the merchant 106. The merchant 106 may authenticate their identity using systems or methods disclosed herein, which may provide the customer with the confidence necessary to expose the merchant to sensitive information.

Techniques consistent with the present disclosure provide, among other features, systems and methods for distributing content to devices, initiating financial transactions, processing electronic financial transactions using a payer device and pay codes, and indirectly controlling websites. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A system for authenticating an entity, comprising:
a database configured to store a profile associated with an entity, the profile including at least an authentication status;
a supplying device configured to supply unique authorization details including at least a payment number to a third party entity to be authenticated;
a receiving means for receiving an authorization request that includes the unique authorization details; and
a processor configured to
capture, from the authorization request, transaction details for a payment card transaction wherein the transaction details includes at least a payment card number,
authenticate the entity requesting a transaction by comparing the captured transaction details including the payment card number to the unique authorization details including the payment number, and
update, in the database, the authentication status in the profile associated with the entity based on the authenticating of the entity based on said authentication.

2. The system of claim 1, wherein the unique authorization details includes at least one of: (1) a unique transaction amount; (2) a unique personal identification number; and (3) a unique combination of traditional transaction details.

3. The system of claim 1, wherein the supplied unique authorization details includes an authentication charge amount and authentication includes comparing a charge amount of said requested transaction to said supplied authentication charge amount.

4. The system of claim 1, wherein no transfer of funds occurs.

5. The system of claim 1, wherein the supplied transaction details further includes a name of the entity and a unique identifier associated with the entity.

6. The system of claim 1, wherein the profile further includes a name of the entity and a unique identifier associated with the entity.

7. The system of claim 5, wherein the supplied transaction details further includes an entity identifier.

8. The system of claim 7, wherein the authenticating the entity further includes comparing the unique identifier associated with the entity with the entity identifier.

9. A method of authenticating an entity, comprising:
storing, in a database configured to store a profile associated with an entity, the profile including at least an authentication status;
supplying unique authorization details including at least a payment number to a third party entity to be authenticated;
receiving an authorization request for a payment card transaction;
capturing, from the authorization request, transaction details for the payment card transaction wherein the transaction details includes at least a payment card number;
authenticating the entity requesting the payment card transaction by comparing the captured transaction details including a payment card number to the unique authorization details including a payment number; and
updating, in the database, the authentication status in the profile associated with the entity based on the authenticating of the entity based on said authentication.

10. The method of claim 1, wherein the unique authorization details includes at least one of: (1) a unique transaction amount; (2) a unique personal identification number; and (3) a unique combination of traditional transaction details.

11. The method of claim 9, wherein the supplied unique authorization details includes an authentication charge amount and authentication includes comparing a charge amount of said requested transaction to said supplied authentication charge amount.

12. The method of claim 9, wherein no transfer of funds occurs.

13. The method of claim 9, wherein the transaction details further includes a name of the entity and a unique identifier associated with the entity.

14. The method of claim 9, wherein the profile further includes a name of the entity and a unique identifier associated with the entity.

15. The method of claim 14, wherein the transaction details further includes an entity identifier.

16. The method of claim 15, wherein the authenticating the entity further includes comparing the unique identifier associated with the entity with the entity identifier.
